(19) United States
(12) Patent Application Publication
(10) Pub. No.: US 2005/0086511 A1
(43) Pub. Date: Apr. 21, 2005

(54) Method of and apparatus for controlling access to data

(76) Inventors: Boris Balacheff, Bristol (GB); David Plaquin, Bristol (GB); Christopher I. Dalton, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/923,250

(22) Filed: Aug. 19, 2004

(30) Foreign Application Priority Data
Aug. 21, 2003 (GB) 0319646.6

(51) Int. Cl. H04L 9/00

(52) U.S. Cl. 713/200

(57) ABSTRACT

Control of access to data within a first data processing device is provided. The data processing device contains at least one data item which has a use policy associated with it. In response to a request from or a requirement of a second data processing device to perform an operation on the data item, the first data processing device seeks information about the ability of the second data processing device to respect conditions specified in the policy and on the basis of a comparison between the policy and the ability of the device to satisfy the policy, the first data processing device decides whether to allow the operation to be performed.

### FIELD OF THE INVENTION

The present invention relates to a method of and apparatus for controlling access to data.

### BACKGROUND OF THE INVENTION

The traditional approach of defining access to data by means of physical security, for example by lack of connectivity or by placing copies of certain items of data onto data carriers or machines to which a recipient has access, can be cumbersome and difficult to administer. Such systems may require the installation of dedicated hardware to enable the sharing of data between two parties.

### SUMMARY OF THE INVENTION

According to a first aspect of the present invention, there is provided a method of controlling access to data contained within a first data processing device, wherein at least one item of data within the first data processing device has a first policy associated with it, wherein, in response to a request from or identifying a need for a second data processing device to make the at least one item of data available to the second processing device such that it can perform an operation on the at least one data item the first data processing device performs the steps of: 1) obtaining information about the ability of the second data processing device to respect and uphold conditions specified in the first policy, and 2) an evaluation step where on a basis of a comparison between the first policy and the ability of the second data processing device to respect and uphold the first policy, the first data processing device decides whether to allow the operation to be performed.

It is thus possible to enable other people or computers to have access to data held by the first data processing device provided that those people or computers are trustworthy. In this context this means that they will respect any restrictions imposed on the use of the data by an owner of the data. Thus trusted networks can be defined on a peer-to-peer basis.

The second data processing device may be a terminal or networked PC wishing to access the data. However, the first data device may wish to push data to the second data processing device, for example during an e-mail send or a back-up procedure.

The first data processing device may require the second data processing device to identify itself or the computing domain it is in, or to identify it's user, and/or to identify it's software, and possibly its hardware, environment.

Thus the user or owner of the second computer may be identified. This is of use where the policy dictates that items of information can be accessed by named individuals, by specified roles and/or specified organisations. Thus if company A has data on it's server and it needs to allow access to a group B of individuals who belong to company C, then these conditions may be specified in the policy. A second computer wishing to access that data will then need to prove (at least to the satisfaction of company A's data processors) that it and it's users satisfy the specified conditions. However, once this has been done the rules relating to the data item are still enforced by the second data processor thereby limiting the actions that a user can undertake.

The operations that the second data processing device wishes to perform may include opening a file, copying a file, deleting a file extracting a portion of data from a file, transmitting in whole or part some of the information contained in the data item or any other task which requires manipulation of the data or which may give rise to propagation of the data.

The first data processing device need not be a single physical device. Thus the device may be a network or computers of may be a virtual device within one or more physical computers.

Preferably the second computer includes policy means, for example a policy enforcement processor, for decoding the policy associated with the at least one data item and for upholding that policy. Thus the policy means intervenes to prevent a user or an application from performing an operation who's properties are not in compliance with the policy associated with the data item.

Preferably the policy means is included within the operating system or the BIOS of the second data processor. This has the advantage that the policy and responsibility for its enforcement can travel with the data item. A system for enforcement of user policy has been the subject of a co-pending application filed by the applicant. A management unit causes the execution of a supervisor code which scans an application until a terminating instruction is reached. In this context a termination instruction is any instruction which causes a change in the flow of instructions that are to be executed. Jump, conditional jump and interrupts are examples of terminating instructions. The scanned code is disassembled and specified instructions are replaced with management instructions, which may themselves depend on the policy instructions associated with a data item that the application is going to operate on.

The policy for the data item may, for example, indicate that the data item cannot be saved to another file name. Consequently those routines or calls in the application that enable this feature may be replaced with a management routine which blocks this operation or which simulates it but does not actually perform it. The decompiled application is then recompiled with modified components.

As an alternative, the policy means may cause the application to be run on a virtual machine simulated within a real data processor. The use of virtual machines is well known to the person skilled in the art. However, the capabilities of and resources accessible to the virtual machine may be limited by the policy means such that the policy can be upheld by the restrictions placed on the virtual machine.

Preferably the second data processing device is a trusted computing platform.

Trusted computing platform (TCP) architectures are based around the provision of a trusted component which is tamper resistant or tamper evident and whose internal processes cannot be subverted. A TCP preferably includes a hardware trusted component which allows an integrity metric (ie. a summary of an integrity measurement) of the platform to be calculated and made available for interrogation. It is this device which underpins the integrity of a TCP. The trusted component can help audit the build of the platform's operating system and other applications such that a user or operator can challenge the platform to verify that it is operating correctly.

Co-pending applications, such as GB 0118455.5 entitled “Audit Privacy” by Hewlett Packard disclose that it is possible to provide an audit process that can verify that a process can be run on a trusted computing platform, that access by the operator or owner of the trusted computing platform to the processes is inhibited, and that access to the audit information is restricted.

The trusted computing platform may be multitasking. It is therefore desirable to ensure that even if the BIOS and operating system are in a trusted state (that is they have not been tampered with and the integrity metric matches that expected by the trusted component), that some other process or application does not violate the policy associated with the data item. The policy may be enforced by the policy means alone. However, advantageously the processes may be run in separate compartments, as described in WO 00/48063.

Thus the computing platform may contain several trusted compartments which may operate at different levels of trust. The trusted compartments isolate the processes running within the compartment from processes in other compartments. They also control access of the processes or applications running therein to platform resources. Trusted compartments have additional properties in that they are able to record and provide proof of the execution of a process and also provide privacy controls for checking that the data is being used only for permitted purposes and/or is not being interrogated by other processes.

The “walls” of compartments may be defined by dedicated hardware or by being defined in software.

Advantageously different policies can be determined for different data items, and indeed for different portions of a single data item.

Advantageously the policy includes data tags which define the policy to be applied to specific sections of a data item. Thus a report may contain a section in which information contained is not confidential and it can be copied and pasted into other documents, but other parts of the report are highly confidential and cannot be copied. The use of tags allow these differing security/access policies to be implemented for different parts of the single report or data item.

The operating system may include a tag association buffer or table which enables it to track and respect the changes in policy which apply to different parts of a data item. Furthermore the table facilitates the re-association of a tag with a data item in the event of the data item being modified.

Preferably the transport of a data item between computers is in accordance with a protocol which establishes a verified and preferably a secure communications path between the devices. Thus the protocol serves to define a mechanism in which the data processors can be sure that a communication originates from the other data processor.

Preferably stages of negotiation and authentication to establish a session key to be used for encryption of data during the communication are performed before the data item is transferred or made available.

Preferably the communications protocol used is the IP-sec protocol. The IP-sec protocol is described in sections, and particular sections of interest include RFC2401 discussing the security architecture, RFC2407 discussing the internet security domain of interpretation for the internet security association and key management protocol (ISAKMP), RFC2408 discussing the internet security association and key management protocol (ISAKMP), and RFC2409 discussing internet key exchange, see www.rfc-editor.org. IPSec is a communication protocol providing both Authentication and Confidentiality over an unsecured communication medium. It is an extension to the standard IP protocol, which ensures its interoperability with existing networking infrastructure (such as switches, routers, etc.). it is implemented in most Operating Systems (Windows 2000, XP and Linux are a few examples). Because of it being a low-level protocol and therefore being implemented within the operating system, this protocol is application independent. This means that even existing applications can take advantages of the security added by IPSec without requiring any modification. This also means that IPSec can transparently secure both TCP and UDP protocols or any other protocol over IP.

The communications protocol may co-operate with the trusted component to define a session key or other data used prove the integrity of the data.

According to a second aspect of the present invention, there is provided a first data processor comprising a policy processor for receiving information concerning the state of a remote data processor requesting access to a data item, and for comparing the status of the remote data processor with a policy associated with the data item an on the basis of that comparison deciding whether to allow the remote data processor access to the data item.

Preferably the remote data processor is a trusted computing device.

Preferably communication between the first data processor and the remote data processor is via a communications protocol that serves to define at least a shared session key for the encryption or for the authentication of data transferred between the data processors.

According to a third aspect of the present invention there is provided a data processor including an information controller for controlling access to at least one item of information contained therein and which has access rules associated with it, wherein the information controller reads the access rules and enforces them.

According to a fourth aspect of the present invention there is provided a method of controlling modification or propagation of data wherein rules concerning how or under what circumstances data may be modified are associated with a data item, and a rule processor within a data processing device enforces those rules.

### BRIEF DESCRIPTION OF THE DRAWINGS

The present invention will further be described, by way of example only with reference to the accompanying drawings, in which:

FIG. 1 is a schematic representation of two computers operating in accordance with the present invention and forming a peer-to-peer network;

FIG. 2 schematically illustrates the policy which may be associated with a data item;

FIG. 3 schematically illustrates the IP-sec protocol;

FIG. 4 schematically illustrates a modified IP-sec protocol where interface with a trusted component is performed; and

FIG. 5 schematically illustrates the creation of dissimilar wall-free networks in accordance with the present invention.

### DESCRIPTION OF PREFERRED EMBODIMENTS

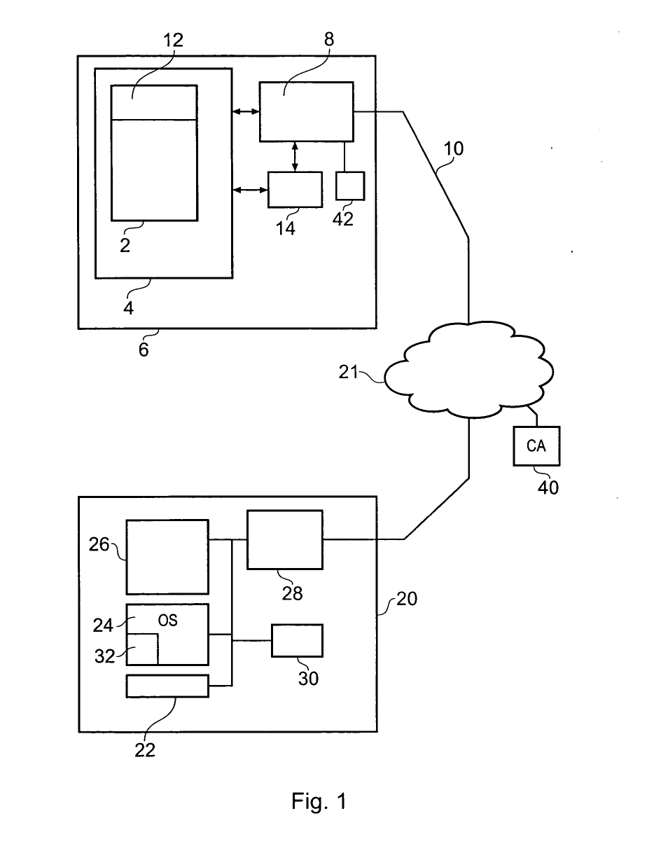

FIG. 1 schematically illustrates an arrangement in which a data item 2 is held within the memory 4 of a computer 6. The data item may, for example, be a document, a presentation, a spreadsheet, an executable, a plan or design, or a directory structure containing many other data items therein. Thus the term “data item” is used broadly to encompass any information contained within the computer 6. The memory 4 may be considered as being any storage device available to the computer 6 and hence includes RAM, magnetic storage media such as hard disk and other storage media such as removable non-volatile memory cards. The computer 6 includes a data processor 8 for controlling access to the memory 4 and communications with other devices via a communications path 10, amongst other things.

The data item 2 has a policy portion 12 associated therewith which defines the use and/or security access rules that have been established by the owner of the data item in relation to a data item. Examples of rules will be given later. The computer 6 also includes a policy checker 14 which is responsive to the policy 12 which is associated with the data item 2. The policy checker may be included within an operating system of the computer 6.

A second computer 20 is one of many computers which is able to establish communications with the first computer 6 via distributed communications system 21 such as a local area network, a wide area network or the internet. The remote computer 20 includes a BIOS 22, an operating system 24 and memory 26 for storing applications and data. The memories 24 and 26 can be regarded as a mixture of non-volatile storage (hard disk) and electronic storage (RAM). The computer 20 also includes a data processor 28 and a trusted component 30. The trusted component 30 is bound tightly to the identity of the computer. The trusted component 30 is advantageously in conformity with the TCPA specification which is available at www.trustedcomputing.org.

Traditionally security systems that have operated within computers have been provided at the application level. Whilst this provides some degree of security it does not guarantee that the operating system or the BIOS has not been tampered with. Within a trusted computing device 20 steps are undertaken to ensure that upon power-up or reset the first code that is executed will be retrieved from the BIOS memory 22. Following execution of a BIOS code, the operating system 24 is then built within the computer.

The trusted component 30, which is typically a tamper resistant hardware component which is manufactured in accordance with strict rules and whose operation is assured because its internal computational processes cannot be subverted, monitors the files and/or data contained within the BIOS and operating system of the computer. The monitoring is dynamic and allows measurements of the computing environment to be made. Thus, for example, before the BIOS routines are executed the trusted component 30 may examine the BIOS and calculate a integrity metric, for example a hash of the BIOS, which can be stored within a memory controlled by the trusted component 30 along with an indication of the current BIOS version within the computer 20. Similarly, as the operating system starts to build integrity measurements of the operating system may be made and stored in a log together with an indication of the components within the operating system. Thus the trusted computing device has a running log of the state of the system and the integrity metrics for the system at any given time. To put this in perspective, the log can contain the identity and version number of each procedure, application, DLL and so on that is running or has been called together with an integrity metric, such as a hash generated by examining the bytes of each item that has been called or executed, such that subversion of the system or mere operation of non-recommended or security weak components can be identified and reported accurately. Once it is known that the BIOS and operating system have not been subverted a greater trust can be placed in the operation of the computing platform and furthermore other security policies either enforced by the operating system or specific applications can then also be given a high level of trust.

It is preferred, but not mandatory, that the operating system 24 includes a policy component 32 which can interpret the policy instructions and ensure that they are enforced.

Supposing that the owner or user of the second computer 20 wishes to have access to the data item 2 stored in the first computer 6. This may, for example, be because the users of the computers are collaborating on a project. The computer 20 then seeks to establish communications with the first computer 6 via the network or internet 21. The establishment of the communications path may itself involve some degree of security authentication, for example if the computer 6 is within a corporate computing zone with access control, for example by using a known password, being implemented. Nevertheless, once communications between the computers 20 and 6 have been established decisions concerning further access of data by the computer 20 within the memory 4 of the computer 6 are made by the policy processor 14. Once communication has been established, the processor 14 instructs the data processor 8 to communicate with the trusted component 30 so as to obtain the log of the components installed within the computer 20 together with the integrity metrics. Thus, the first computer starts the step of obtaining information about the second computing device and in particular its ability to respect and uphold any policies that are associated with the data items. The computer 20 has a choice, as defined by its security policy, whether to reveal the contents of its integrity metric or metrics. For privacy reasons the computer 20 could refuse to reveal its metrics to the computer 6. However, under those circumstances it is likely that the computer 6 would refuse to carry on the interaction with the computer 20 as it would not have enough information to evaluate the trustworthiness of the computer 20. Thus there is a tension between privacy and policy enforcement. However, since in this example the computer 20 has initiated the contact with the first computer 6, it or its user will probably release its integrity metric for evaluation. It can also be supposed that higher value items of information may require more proof of integrity to be given than would be the case for lower value items of information. The level of proof required may also vary as a function of the “position” of the computer 20. Thus if the computer 20 is within the same ownership domain, e.g. same corporate ownership, as the computer 6 then the computer 20 may be inherently deemed to be more trustworthy. The data from the trusted component 30 will be signed by the component 30 in order to authenticate that the data was provided by that component. The authentication signature is encrypted and the key needed to decrypt the signature either has already been made available to the computer 6 or alternatively reference may be made to a certification authority 40 which is a trusted authority and which knows some of the secrets contained within the trusted component 30 and which can use its knowledge to certify that the data log provided by the trusted component 30 was actually signed by that component. In a preferred implementation, the build log and integrity metrics are also passed in encoded form. It is advantageous if the first computer 6 also includes a trusted component 42 such that the trusted components 30 and 42 can negotiate with one another and mutually authenticate each other's identity before exchange of the build and integrity metric data. Once the state of the second computer 20 has been made available to the policy processor 14 it can then check to see what level of access it should grant either to the directory structure within the memory 4 or to individual files. The policy processor may operate at many levels. Thus it may be sufficient that the second computer is operating on a specified operating system as that may in itself be deemed to have sufficient intrinsic policy enforcement processes to allow the data to be made available to the second computer. However some data items may be more sensitive than others. Thus an attempt to access a more sensitive data item may result in the first computer 6 determining that it has insufficient information to determine if the second computer can be allowed to access the more sensitive data item. Under these circumstances the first computer can request additional information, or even down load security programs to the second computer in an attempt to ensure that the second computer is, or can be placed in, a sufficiently trusted state.

In an embodiment where policies are enforced on a file by file basis, we can consider the situation where the computer 20 wishes to access the data item 2. For each item of data leaving (and optionally entering) the computer 6 a policy must be associated with the data. The policy states how the data is to be protected including when it leaves the domain of the computer 6. Therefore when some data is to leave the computer 6 for another destination, e.g. computer 20, the computer 6 must evaluate the trustworthiness of the computer 20 to determine if it can enforce the policy associated with the data.

Following the communication by computer 20 of its integrity metrics, the computer 6 can perform an evaluation step where it compares the build and integrity of the computer 20 with a global security policy and/or specific policies associated with the data to decide whether to communicate the information to the computer 20. The computer 6 may base its decision on an evaluation of one or more of the BIOS, operating system, configuration information, network environment, applications being run, or destination application. This list is only exemplary and is not to be considered as being exhaustive.

If the computer 6 is not satisfied with the level of trust (trustworthiness) of the computer 20, the policy should also state what action is to be taken. Some of the actions may be:
1) abort the communication;
2) inform the computer 20 that it is not deemed to be trustworthy, give it reasons, and ask it to comply with the policy if possible;
3) use an alternative process to protect the data such as encrypting the data. The encryption may involve the participation of a third party;
4) carry on with the communication but to audit this action and to report it.

The above actions are only examples and the list is not to be considered as being exhaustive.

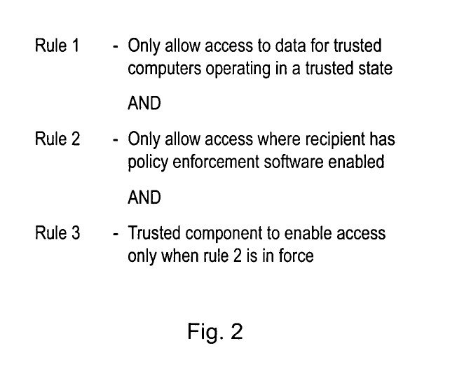

Upon computer 20 sending a request to open or copy the data item 2, the policy processor 14 interrogates the policy 12 associated with the data item 2 in order to interpret the policies contained therein. FIG. 2 schematically shows an example of the policy 12 which may be implemented.

The policy can include several policy statements or rules which may be combined using logical operators. Thus in this simple example, rule 1 states the document should only be made available to computers which are trusted computers and which are operating in a trusted state. The “trusted state” will need to be defined, but it may for example specify a range of BIOS configurations and operating systems together with their revision levels. The schedule of system components and integrity metrics is provided by the trusted component 30 in order to determine whether or not rule 1 is satisfied.

Rule 2 in this example requires that the operating system should include the policy enforcement component 32 and that this component is in an enabled state. This means that, in the event that the data item 2 is copied to the remote computer 20 its associated policy 12 will go with it and the computer 20 will assume responsibility for enforcing the rules within the policy 12. The 3rd rule takes advantage of the trusted component's ability to associate a cryptographic key with the copied version of the data item such that in the event that a copy of the data item 2 is made in the computer 20 and then an administrator seeks to disable the policy enforcement software, the trusted component 30 can be trusted to refuse to release the key to the operating system to enable the data within the data item to be opened. It can thereby be ensured that the data item 20, if copied to the computer 20, can still only be accessed when the computer 20 satisfies the conditions as determined by the policy processor 14 which enabled it to be transported to the computer 20 in the first place.

As noted hereinbefore, different security policies can be applied to different parts of a data item. Therefore the test applied in relation to the rule 2 may also seek to check the capabilities of the operating system, and in particular of the policy enforcement part thereof to understand the instructions pertaining to decoding data tags specifying different security policies for different portions of the data item.

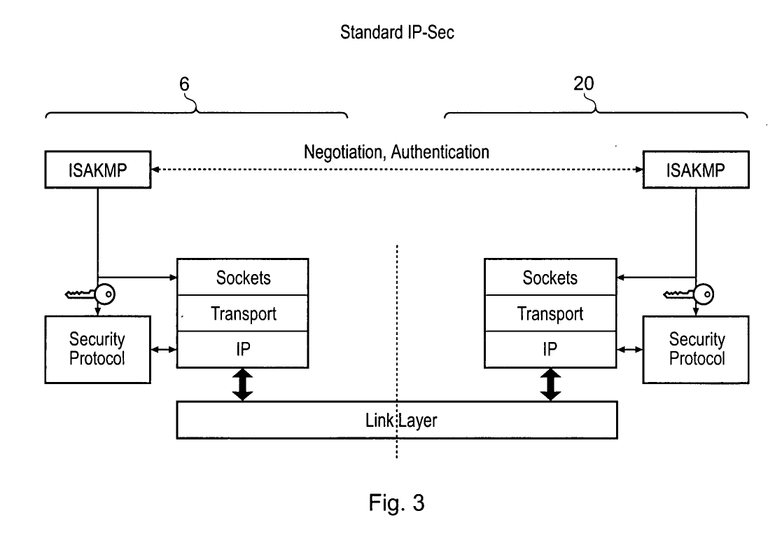

If is of course important that communications between the computers 6 and 20 are secure. In this context this means that the computers 6 and 20 can confirm the identity of each other and preferably that no-one else can intercept the content of the communication. A known and commonly used communications technology is the IP-sec protocol, although it should be noted that other protocols might also be suitable for use. FIG. 3 schematically illustrates the standard IP-sec stack. The left hand side of the diagram can be considered as being implemented in the computer 6 whereas the right hand side is implemented in the computer 20. The establishment of an IPSec connection requires multiple successive stages. The first stage is a negotiation phase where the device (computer 20) willing to initiate a communication contacts a remote device (computer 6) and starts to negotiate various parameters of the connection such as supported algorithms and minimal security requirement. This first interaction is made using standard and unsecured IP.

During this negotiation stage, a shared secret is established using ISAKMP (Internet Security Association Key Management Protocol), which is an IPSec related implementation of the IKE (Internet Key Exchange) protocol. This shared secret between the two devices define what is called a Security Associate (SA). This SA allows the two entities that have established the shared secret to safely communicate using this secret for both encryption and origin authentication. (Actually, in practice two shared secrets are generated from the main Security Association and these secrets are used one as an encryption session key and the other as an authentication session key).

The second stage is the device authentication step. During this stage, one or both of the communication devices authenticates itself by cryptographic means. The authentication can be either based on Public Key Algorithm (such as RSA) or using a beforehand agreed shared secret (such as a password with HMAC algorithm). Once authenticated, each device can bind the identity of the other device to the Security Association previously established for the whole time during which the communication takes place. If another Security Associate is needed later (in order to create a new connection using a different protocol or a different address port) the main SA is used to generate the additional SA, which will then be used to secure the new connection.

A more detailed description can be found at http://www.sans.org/rr/protocols/Ipsec.php.

The socket layers within a stack provide an interface between the various applications running within the computer and the transport layer which further encodes the data for transport according to internet protocols along the link layer, which generally comprises the physical communications path. The IP-sec protocol in conjunction with the operating system can be arranged to inform the co-operating computer of a change in the computer's configuration during the communication session. This ability to inform the other computer of the change means that, in the event of a change occurring, the communication can be suspended whilst the level of trust of the altered computer is re-evaluated.

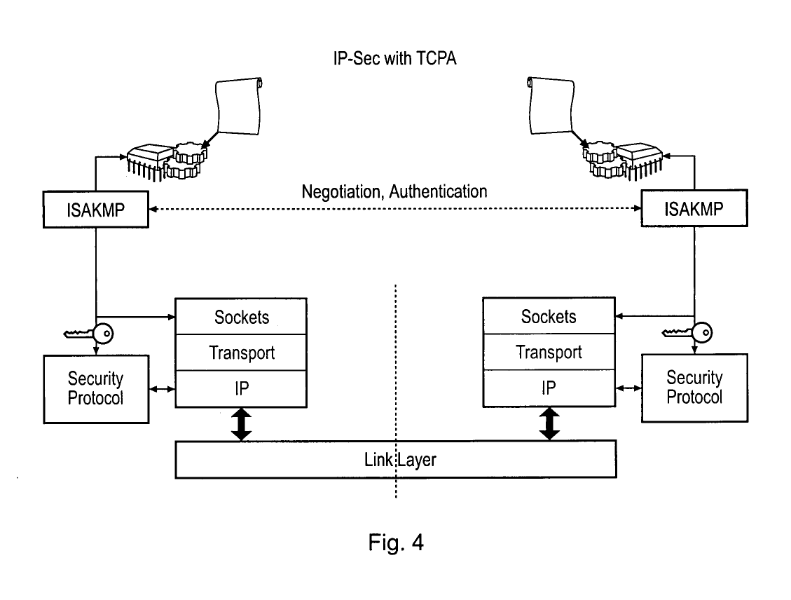

FIG. 4 shows a modification to the standard IP-sec stack in which the trusted component participates in the authentication procedure such that some integrity and configuration information is sent along with the signature of the trusted component. In this arrangement the shared secret between the two computers not only represents a successful mutual authentication but also a successful negotiation of the desired security policies associated with the data item.

The policy processor 14 may itself be implemented as a software component within the operating system kernel or within the IP-sec stack (or within any other communications scheme that is invoked).

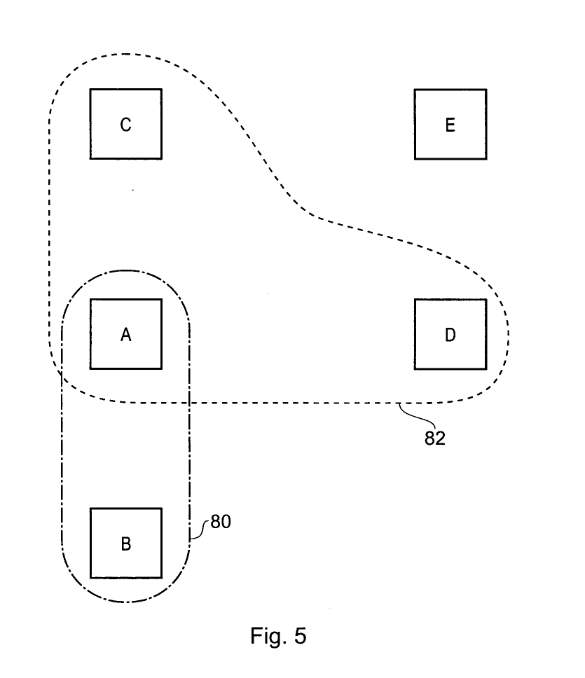

The present invention allows secure networks to be defined not by their physical boundaries but by the use that is to be made of the information contained within the network. This is better illustrated in FIG. 5. Suppose that a data processing environment owned by company A needs to share some data with the computer of company B in order to collaborate on a first project but also needs to share data with companies C and D in order to collaborate on a second project. The rules associated with any data item may specify whether that data item is allowed outside of company A and if so may also specify with which companies the data can be shared. In this way certain data items may only be shared with company B, thereby effectively creating a first secure network between companies A and B as defined by the chain-dot line 80, whereas other documents are only shared by companies A, C and D thereby defining a second secure network defined by the chain line 82. If a company does not satisfy any of the security policies and hence no documents are shared with it even though each company may choose to communicate generally with all of the others via e-mail using a web based service.

It thus becomes possible to define secure networks on a peer-to-peer basis rather than using the traditional dedicated hardware security model which hitherto has been widely used. In general human interaction or decisions concerning release of data are not required on a day to day basis. However, for information that a user is particularly sensitive about, the user could instruct the policy to inform him each time a request is made to manipulate that information. The user may also indicate that he/she has to give specific authorisation to release that information.

1. A method of controlling access to data contained within a first data processing device, wherein at least one item of data within the first data processing device has a first policy associated with it, wherein, in response to a request from or identifying a need for a second data processing device to make the at least one item of data available to the second processing device such that it can perform an operation on the at least one data item the first data processing device 1) obtains information about the ability of the second data processing device to respect and uphold conditions specified in the first policy, and 2) on a basis of a comparison between the first policy and the ability of the second data processing device to respect and uphold the first policy, the first data processing device decides whether to allow the operation to be performed.

2. A method as claimed in claim 1, in which the first data processor requires the second data processor to identify at least one of its identity, its users identity and the computing domain it exists in.

3. A method as claimed in claim 1, in which the first data processor requires the second data processor to provide data concerning its software and/or hardware environment.

4. A method as claimed in claim 3, in which the first data processor requires the second data processor to provide information which can be used to determine the trust that can be placed in the second data processor.

5. A method as claimed in claim 4, in which the first data processor seeks build logs and integrity metrics from the second data processing device.

6. A method as claimed in claim 4, in which the first data processor seeks confirmation that the second data processing device is a trusted device.

7. A method as claimed in claim 1, in which the first data processing device seeks confirmation that the second data processing device includes a policy processor for reading and enforcing the policy associated with the at least one data item.

8. A method as claimed in claim 7, in which the policy means in the second data processing device only allows the data item to be processed in accordance with its associated policy.

9. A method as claimed in claim 7, wherein the policy contains different rules for different parts of a data item.

10. A method as claimed in claim 6, in which the first computing device requires that processes running within the second data processing device are in separate compartments.

11. A method as claimed in claim 1, in which communication between the first and second data processing devices is via a protocol which establishes a verified communications path between the devices.

12. A method as claimed in claim 1, in which the communication between the first and second data processing devices is via a protocol which establishes a secure communications path between the devices.

13. A method as claimed in claim 11, in which communication is performed using IP-sec protocol.

14. A method as claimed in claim 13, in which the first and second data processing devices include trusted components, and the trusted components participate in authentication of the communication path.

15. A data processor comprising a policy processor for receiving information concerning the state of a remote data processor requesting or requiring access to a data item, and wherein, in use, the policy processor compares the status of the remote data processor with a policy associated with that data item and on the basis of the comparison decides whether to allow the remote data processor access to the data item.

16. A data processor as claimed in claim 15, further comprising a communications device for establishing communication via a protocol which defines at least one of a session key for signing data and a session key for encrypting data.

17. A method of defining secure networks by way of reference to the use that is to be made of a data item within a first data processing device where the first data processing device is in communication with second and third data processing devices such that the second and third data processing devices can access or manipulate data items within the first data processing device and where the first and second data processing devices form a first secure network with regards to a first set of data such that access to the first set of data is inhibited to the third data processor, and where in response to a request from or identifying a need for one of the second and third data processors to make a data item available to the processor making the request such that it can perform an operation on the data, the first data processing device 1) obtains information about the ability of the data processing device making the request to respect and uphold conditions specified in a policy associated with the data, and 2) on a basis of a comparison between the first policy and the ability of the data processing device making the request to respect and uphold the policy, the first data processing device decides whether to allow the operation to be performed.

18. A method as claimed in claim 17, in which the first data processing device requires the data processing device making the request to identify at least one of its identity, its user's identity and the computing domain it exists in.

19. A method as claimed in claim 17, in which the first processing device seeks confirmation that the processing device making the request includes a policy processor for enforcing the policy associated with the data item.
